(19) United States
(12) Patent Application Publication
(10) Pub. No.: US 2016/0171739 A1
(43) Pub. Date: Jun. 16, 2016

(54) AUGMENTATION OF STOP-MOTION CONTENT

(71) Applicant: Intel Corporation, Santa Clara, CA (US)

(72) Inventors: Glen J. Anderson, Beaverton, OR (US); Wendy March, Portland, OR (US); Kathy Yuen, Portland, OR (US); Ravishankar Iyer, Portland, OR (US); Omesh Tickoo, Portland, OR (US); Jeffrey M. Ota, Morgan Hill, CA (US); Michael E. Kounavis, Portland, OR (US)

(21) Appl. No.: 14/567,117

(22) Filed: Dec. 11, 2014

(51) Int. Cl. G06T 13/80; G06T 19/00

(52) U.S. Cl. CPC G06T 13/80; G06T 19/006

(57) ABSTRACT

Apparatuses, methods and storage media for providing augmented reality (AR) effects in stop-motion content are described. In one instance, an apparatus may include a processor, a content module to be operated by the processor to obtain a plurality of frames having stop-motion content, some of which may include an indication of an augmented reality effect, and an augmentation module to be operated by the processor to detect the indication of the augmented reality effect and add the augmented reality effect corresponding to the indication to some of the plurality of frames. Other embodiments may be described and claimed.

### TECHNICAL FIELD

The present disclosure relates to the field of the field of augmented reality, and in particular, to adding augmented reality effects to stop-motion content.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Stop-motion is animation technique to make a physically manipulated object or persona appear to move on its own. Currently, stop-motion animation content may be created by taking snapshot images of an object, moving the object slightly between each snapshot, then playing back the snapshot frames in a series, as a continuous sequence, to create the illusion of movement of the object. However, under existing art, creating visual or audio effects (e.g., augmented reality effects) for stop-motion content may prove to be a difficult technological task that may require a user to spend substantial time, effort, and resources.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the Figures of the accompanying drawings.

FIG. 1 is a block diagram illustrating an example apparatus 100 for providing augmented reality (AR) effects in stop-motion content, in accordance with various embodiments.

FIG. 2 illustrates an example of addition of an AR effect to stop-motion content using techniques described in reference to FIG. 1, in accordance with some embodiments.

FIG. 3 illustrates an example process for adding an AR effect to stop-motion content, in accordance with some embodiments.

FIG. 4 illustrates an example routine for detecting an indication of an AR effect in stop-motion content, in accordance with some embodiments.

FIG. 5 illustrates an example computing environment suitable for practicing various aspects of the disclosure, in accordance with various embodiments.

### DETAILED DESCRIPTION

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Computing apparatuses, methods and storage media associated with providing augmented reality (AR) effects to stop-motion content are described herein. In one instance, the apparatus for providing augmented reality (AR) effects in stop-motion content may include a processor, a content module to be operated by the processor to obtain a plurality of frames having stop-motion content, some of which may include an indication of an augmented reality effect, and an augmentation module to be operated by the processor to detect the indication of the augmented reality effect, and add the augmented reality effect corresponding to the indication to some of the plurality of frames having stop-motion content.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “logic” and “module” may refer to, be part of, or include an application specific integrated circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

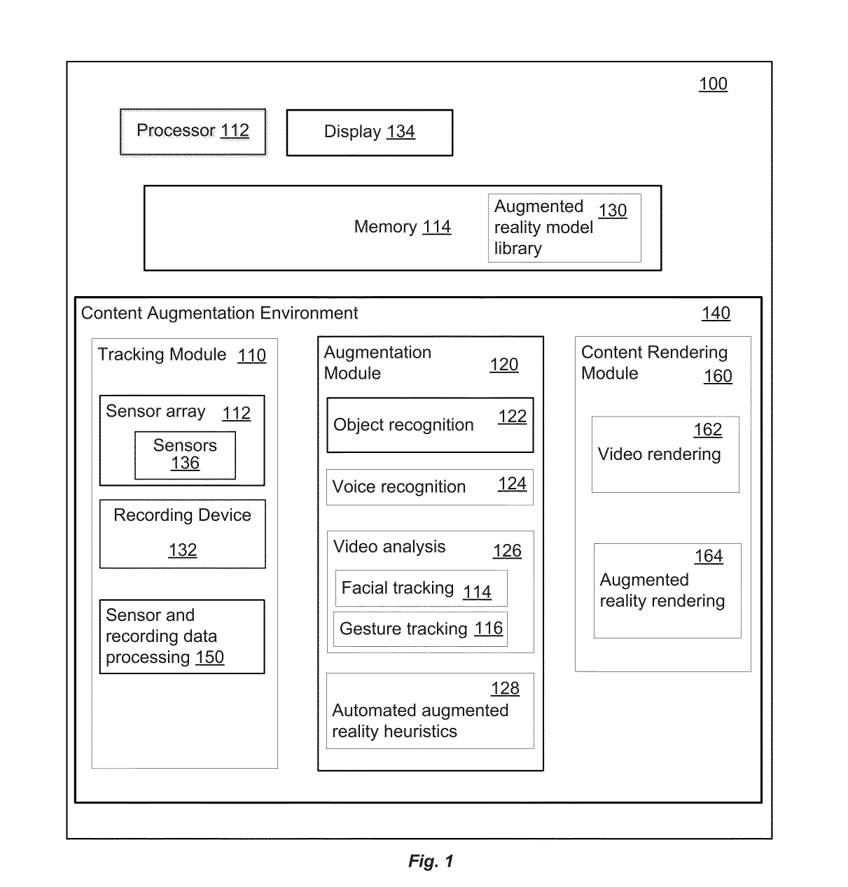

FIG. 1 is a block diagram illustrating an example apparatus 100 for providing AR effects to stop-motion content, in accordance with various embodiments. As illustrated, the apparatus 100 may include a processor 112, a memory 114, content augmentation environment 140, and display 134, communicatively coupled with each other.

The content augmentation environment 140 may include a tracking module 110, augmentation module 120, and content rendering module 160 configured to provide stop-motion content, detect indications of AR effects in the content, and augment stop-motion content according to detected indications.

The tracking module 110 may be configured to track the indications of the AR effect. The tracking module 110 may include a sensor array module 112 that may comprise a plurality of sensors 136 to track the indications of AR effects that may distributed across the apparatus 100 as described below. The sensors 136 may include proximity sensors, inertial sensors, optical sensors, light sensors, audio sensors, temperature sensors, thermistors, motion sensors, vibration sensors, microphones, cameras, and/or other types of sensors. The sensors 136 may further include touch surface (e.g., conductive) sensors to detect indications of AR effects.

The sensors 136 may be distributed across the apparatus 100 in a number of different ways. For example, some sensors (e.g., a microphone) may reside in a recording device 132 of the tracking module 110, while others may be embedded in the objects being manipulated. For example, a sensor such as a camera may be placed in the object in the scene in order to capture a facial expression of the user, in order to detect an indication of an AR effect; motion sensors (e.g., accelerometers, gyroscopes and the like) may be placed in the object to detect position and speed change associated with the object, and the like. Microphones may also be disposed in the objects in the scene, to capture audio associated with the stop-motion content. Touch surface sensors may be disposed in the objects in the scene, to detect indications of AR effects if desired.

The recording device 132 may be configured to record stop-motion content in the form of discrete frames or a video, and for tracking video and audio indications that may be associated with the stop-motion content during or after the recording. The recording device 132 may be embodied as any external peripheral (not shown) or integrated device (as illustrated) suitable for capturing images, such as a still camera, a video camera, a webcam, an infrared (IR) camera, or other device capable of capturing video and/or images. In some embodiments, the recording device 132 may be embodied as a three-dimensional (3D) camera, depth camera, or bifocal camera, and/or be otherwise capable of generating a depth image, channel, or stream. The recording device 132 may include a user interface (e.g., microphone) for voice commands applied to stop-motion content, such as commands to add particular narrative to content characters.

Accordingly, the recording device 132 may be configured to capture (record) frames comprising stop-motion content (e.g., with the camera) and capture corresponding data, e.g., detected by the microphone during the recording. Although the illustrative apparatus 100 includes a single recording device 132, it should be appreciated that the apparatus 100 may include (or associated with) multiple recording devices 132 in other embodiments, which may be used to capture stop-motion content, for example, from different perspectives, and to track the scene of the stop-motion content for indications of AR effects.

The tracking module 110 may include a processing sub-module 150 configured to receive, pre-process (e.g., digitize and timestamp) data provided by the sensor array 112 and/or microphone of the recording device 132 and provide the pre-processed data to the augmentation module 120 for further processing described below.

Augmentation module 120 may include an object recognition sub-module 122 configured to recognize objects in the frames recorded for stop-motion content, and to associate indications of AR effects, when detected, with recognized objects. The object recognition sub-module 122 may be configured to recognize objects in video and/or audio streams provided by the recording device 132. Some of the recognized objects may include markers, stickers, or other indications of AR effects. The detected indications may be passed on to augmented reality heuristics sub-module 128 for further processing discussed below.

Augmentation module 120 may include a voice recognition sub-module 124 configured to recognize voice commands provided (e.g, via tracking module 110) by the user in association with particular frames being recorded for stop-motion content, and determine indications of AR effects based at least in part on the recognized voice commands. The voice recognition sub-module 124 may include a converter to match character voices, for whom the voice commands may be provided, configured to add desired pitch and tonal effects to narrative provided for stop-motion content characters by the user.

Augmentation module 120 may include a video analysis sub-module 126 configured to analyze stop-motion content to determine visual indications of AR effects, such as fiducial markers or stickers provided by the user in association with particular frames of stop-motion content. The video analysis module 126 may be further configured to analyze visual effects associated with stop-motion content that may not necessarily be provided by the user, but that may serve as indications of AR effects, e.g., represent events such as zoom-in, focusing on particular object, and the like.

The video analysis sub-module 126 may include a facial tracking component 114 configured to track facial expressions of the user (e.g., mouth movement), detect facial expression changes, record facial expression changes, and map the changes in user's facial expression to particular frames and/or objects in frames. Facial expressions may serve as indications of AR effects to be added to stop-motion content, as will be discussed below. For example, the video analysis sub-module 126 may analyze user and/or character facial expressions, for example, to synchronize mouth movements of the character with audio narrative provided by the user via voice commands.

The video analysis sub-module 126 may further include a gesture tracking component 116 to track gestures provided by user in relation to particular frames of the stop-motion content being recorded. Gestures, alone or in combination with other indications, such as voice commands, may serve as indications of AR effects to be added to stop-motion content, as will be discussed below.

The video analysis sub-module 126 may be configured to recognize key colors in markers inserted by the user in the frame being recorded, to trigger recognition of faces and key points of movement of characters, to enable the user to insert a character at a point in the video by placing the marker in the scene to be recorded. The video analysis sub-module 126 may be configured to identify the placement of AR effects in a form of visual elements, such as explosions, smoke, skid marks, based on objects detected in the video. Accordingly, the identified AR effects may be placed in logical vicinity and orientation to objects detected in the video by the video analysis sub-module 126.

Augmentation module 120 may include automated AR heuristics sub-module 128 configured to provide the associations of particular AR effects with particular events or user-input-based indications of AR effects identified by modules 120, 122, 124, 126. For example, the automated AR heuristics module 128 may include rules to provide AR effects in association with sensor readings or markers tracked by the sensor array 112. The examples of rules may include the following: If acceleration event of an object in frame is greater than X and orientation is less than Y, then make wheel-screech sound for N frames; If acceleration event of an object in frame is greater than X and orientation greater than Y, then make crash sound for N frames; If block Y is detected in a frame of the video stream, add AR effect Y in the block Y area of the video for a duration of the block Y presence in the frames of the video stream.

The content augmentation environment 140 may further include a content rendering module 160. The content rendering module may include a video rendering sub-module 162 and AR rendering sub-module 164. The video rendering sub-module 162 may be configured to render stop-motion content captured (e.g., recorded) by the user. The AR rendering sub-module 164 may be configured to render stop-motion content with added AR effects. The AR rendering sub-module 164 may be configured to post stop-motion content to a video sharing service where additional post-processing to improve stop motion effects may be done.

The apparatus 100 may include AR model library 130 configured as repository for AR effects associated with detected indications or provided by the rules stored in automated AR heuristics module 128. For example, the AR model library 130 may store an index of gestures, voice commands, or markers with particular properties and corresponding AR effect software. For example, if a marker of yellow color is detected as an indication of an AR effect, the corresponding AR effect that may be retrieved from AR model library 130 may comprise yellow smoke. In another example, AR model library 130 may store AR effects retrievable in response to executing one of the rules stored in automated AR heuristics sub-module 128. For example, the rules discussed above in reference to automated AR heuristics sub-module 128 may require a retrieval of a wheel-screech sound or crash sound from AR model library. In some embodiments, the AR model library 130 may reside in memory 114. In some embodiments, the AR model library 130 may comprise a repository accessible by indication detection module 120 and content rendering module 160.

Additionally, in some embodiments, one or more of the illustrative components may be incorporated in, or otherwise form a portion of, another component. For example, the memory 114, or portions thereof, may be incorporated in the processor 112 in some embodiments. In some embodiments, the processor 112 and/or memory 114 of the apparatus 100 may be configured to process data provided by the eye tracker 110. It will be understood that augmentation module 120 and content rendering module 160 may comprise hardware, software (e.g., stored in memory 114), or a combination thereof.

It should be appreciated that, in some embodiments, any or all of the illustrated components, such as the recording device 132 and/or the sensor array 112 may be separate from and remote to, but communicatively coupled with, the apparatus 100. In general, some or all of the functionalities of the apparatus 100, such as processing power and/or memory capacity may be used or shared with the augmentation environment 140. Furthermore, at least some components of the content augmentation environment (e.g., library 130, processing sub-module 150, augmentation module 120 and content rendering module 160 may be accessible by (e.g., communicatively coupled with) the apparatus 100, but may not necessarily reside on the apparatus 100. One or more of the components mentioned above may be distributed across the apparatus 100 and/or reside on a cloud computing service to host these components.

In operation, obtaining stop-motion content with added AR effects using the apparatus 100 may include the following actions. For example, the user may take individual snapshots or capture a video for stop-motion content (e.g., animation). The user may either manipulate (e.g., move) one or more objects of animation and capture the object(s) in a new position, or take a video of the object(s) in the process of object manipulation. As a result, the user may create a series of frames that may include one or more objects of animation, depending on the particular embodiment. The stop-motion content captured by the recording device 132 may be recorded and provided to content module 160 for rendering or further processing. The content module 160 may render the obtained stop-motion content to content augmentation environment 140 for processing and adding AR effects as discussed below.

The user may also create indications of desired AR effects and associate them with the stop-motion content. The indications of AR effects may be added to the stop-motion content during creation of content or on playback (e.g., by video rendering sub-module 162) of an initial version of the stop-motion content created as described above. The user may create the indications of AR effects in a variety of ways. For example, the user may use air gestures, touch gesture, gestures of physical pieces, voice commands, facial expressions, different combinations of voice commands, and facial expressions, and the like.

Continuing with the gesture example, the user may point to, interact with, or otherwise indicate an object in the frame that may be associated with an AR effect. The gesture, in addition to indication of an object, may indicate a particular type of an AR effect. For example, particular types of gestures may be assigned particular types of AR effects: a fist may server as an indication of an explosion or a fight, etc.

A gesture may be associated with a voice command (e.g., via the recording device 132). For example, the user may point at an object in the frame and provide an audio command that a particular type of AR effect be added to the object in the frame. A gesture may indicate a duration of the AR effect, e.g., by indicating a number of frames for which the effect may last.

In some embodiments, the voice commands may indicate an object (e.g., animation character) and a particular narrative that the character may articulate. The user may also use facial expressions, for example, in association with a voice command. The voice command may also have an indication of duration of the effect. For example, a length of a script to be articulated may correspond to a particular number of frames during which the script may be articulated. In another example, the command may directly indicate the temporal character of the AR effect (e.g., “three minutes,” “five frames” or the like). As described above, user input such as voice commands, facial expressions, gestures, or a combination thereof may be time-stamped at the time of input, to provide correlation with the scene and (frame(s)) being recorded.

The user may create the indications of AR effects using markers (e.g., objects placed in the scene of stop-motion content to be recorded). For example, the user may use fiducial markers or stickers, and associate the markers or stickers with particular scenes and/or objects in the scenes that may be captured as one or more frames, to create indications of desired AR effects. For example, the user may place a marker in the scene to be captured to indicate an object in the scene to be associated with an AR effect. The marker may also indicate a type of an AR effect. The marker may also indicate a temporal characteristic (e.g., duration) of the effect.

For example, different colors may correspond to different number of frames or periods of time during which the corresponding AR effect may last. In another example, an inclusion of a marker in a certain number of frames and subsequent exclusion of the marker may indicate the temporal characteristic of the AR effect. In another example, a fiducial marker may add a character to a scene to be captured. For example, a character may be a “blank” physical block that may get its characteristics by the fiducial marker that may be applied.

Indications of desired AR effects may not necessarily be associated with user input described above. In other words, AR effects may be added to stop-motion content automatically in response to particular events in the context of a stop-motion animation, without the user making purposeful indications. Some indications of AR effects may comprise events that may be recognized by the apparatus 100 and processed accordingly. For example, the user may add sensors to objects in the scene to be captured, such as using sensor array 112 of the tracking module 110. As described above, the sensors may include proximity sensors, inertial sensors, optical sensors, light sensors, audio sensors, temperature sensors, thermistors, motion sensors, touch, vibration sensors, and/or other types of sensors.

The sensors may provide indications of object movement (e.g., accelerometers, gyroscopes, and the like), to be recorded by the recording device 132, e.g., during recording stop-motion content. For example, continuous stream of accelerometer data may be correlated with timestamps to video frames comprising stop-motion animation. When an accelerometer event is detected (e.g., change of acceleration parameter above a threshold may be detected by the augmentation module 120), the first correlating frame may be one in which a corresponding AR effect, when added, may begin.

For example, if an object of animation is a vehicle, a tipping and subsequent “crash” of the vehicle in the video content may cause the accelerometer embedded in the vehicle vent. Accordingly, an indication of an AR effect (e.g., a sound of explosion and/or smoke) may be produced, to be detected by the augmentation module 120. In another example, if an object (vehicle) tips approximately at 90 degree angle (which may be detected by the augmentation module 120), a crash or thud sound may need to be added. However, if the accelerometer position changes back within a few frames, the system may stop the AR effect e.g., smoke or squeal of the wheels). For example, if there is an accelerator associated with the object in the scene that allows detection of movement, e.g., tipping or sudden stops, an AR effect (e.g., sound effect) may be added even though the user did not expressly request that effect.

In another example, the video comprising the stop-motion content may be analyzed and an indication of AR effect may be discerned from other types of events, such as a camera zooming in or focusing on a particular object, a facial expression of a character in the scene, or the like. In another example, the stop-motion content may be analyzed to determine that a particular sequence of situations occurring in a sequence of frames, in some instances in combination with corresponding sensor reading change or camera focus change, may require an addition of an AR effect. For example, the analysis the zooming in on an object in combination with detecting a change of speed of the object may lead to a determination that a collision of the object with an obstacle or another object may be anticipated, and a visual and or sound AR effect may need to be added to the stop-motion content.

If the augmentation module 120 detects an indication of AR effect (either user-input-related or event-related as described above), the augmentation module may retrieve an AR effect corresponding to the indication and associate the AR effect with stop-motion content, e.g., by determining location (placement) of the AR effect in the frame and duration of the AR effect (e.g., how many frames may be used for the AR effect to last). The placement of the AR effect may be determined from the corresponding indication. For example, gesture may point at the object with which the AR effect may be associated. In another example, a voice command may indicate a placement of the AR effect. In another example, a marker placement may indicate a placement of the AR effect.

Similarly, duration of the AR effect may be determined by user via a voice command or other indication (e.g., marker color), as described above. In another example, duration of the AR effect may be associated with AR effect data and accordingly may be pre-determined. In another example, duration of the AR effect may be derived from the frame by analyzing the objects within the frame and their dynamics (e.g., motion, movement, change of orientation or the like). In the above example of a vehicle animation discussed above, the vehicle may be skidding for a number of frames, and corresponding sound effect may be determined to last accordingly.

Once the placement and duration of the AR effect is determined, the AR effect may be associated with the stop-motion content (e.g., by augmented reality rendering sub-module 164). In some embodiments, the association may occur during the recording and rendering of the initial version of stop-motion content. In some embodiments, the initial version of the stop-motion content may be first recorded and the AR effect may be associated with the content during rendering of the stop-motion content. In some embodiments, association of the AR effect with stop-motion content may include adding the AR effect to stop-motion content (e.g. placing the effect for the determined duration in the determined location). In another example, the association may include storing information about association (e.g., determined placement and duration of the identified AR effect in stop-motion content), and adding the AR effect to stop-motion content in another iteration (e.g., during another rendering of the stop-motion content by video rendering sub-module 162).

Once the identified AR effect is added to stop-motion content as described above, the stop-motion content may be rendered to the user, e.g., on display 134. As described above, the stop-motion content may be created in a regular way, by manipulating objects and recording snapshots (frames) of resulting scenes. In embodiments, the stop-motion content may be captured in a form of a video of stop-motion animation creation and subsequently edited. For example, the frames that include object manipulation (e.g., by user's hands or levers or the like) may be excluded from the video, e.g., based on analysis of the video and detecting extraneous objects (e.g., user's hands, levers, or the like). Converting the video into the stop-motion content may be combined with the actions aimed at identifying AR effects and adding the identified AR effects to stop-motion content, as described above. In some embodiments, converting the video into stop-motion content may take place before adding the identified AR effects to stop-motion content.

In another example, a manipulated block may have a touch sensitive surface, enabled, for example, by capacitance or pressure sensitivity. If the user touches the touch sensitive block while speaking, the user's voice may be attributed to that block. The block may have a story-based character associated with it, thus, as described above, the user's voice may be altered to sound like that character in the stop-motion augmented reality video. In another example, the user may hold a touch sensitive block while contorting his or her face. In one example, the touch to the block and the face of the person may be detected and an analysis of the human facial expression to the block in the stop-motion augmented reality video may be applied.

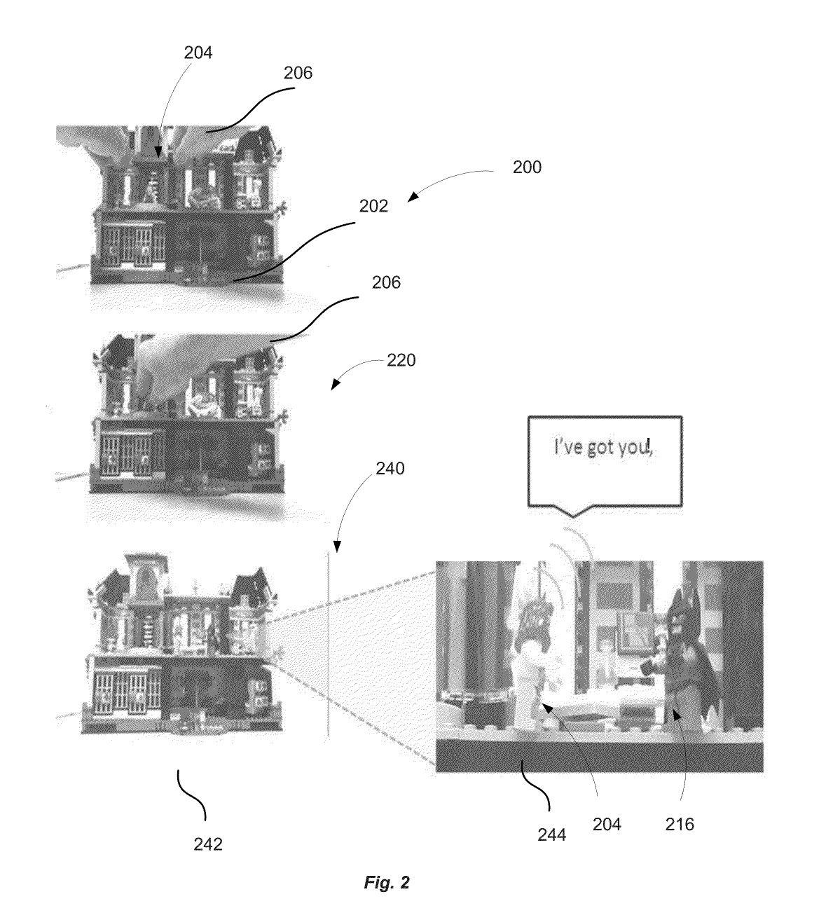

FIG. 2 illustrates an example of addition of an AR effect to stop-motion content using techniques described in reference to FIG. 1, in accordance with some embodiments. View 200 illustrates a creation of a scene for recording stop-motion content. An object 202 (e.g., a house with some characters inside, including Character 1 204) is being manipulated by user's hands 206. View 220 illustrates a provision of an indication of a desired AR effect by the user. User's hand 206 is shown as providing a gesture indicating an object (in this case, pointing at or fixing a position of Character 1 204, not visible in view 220), with which the desired AR effect may be associated. The user may also issue a voice command in association with the gesture. For example, the user may issue a voice command indicating a narrative for Character 1 204. In this case, the narrative may include a sentence “I've got you!” The indication of AR effect may include a gesture indicating a character that would say the intended line, and the line itself. The indication of the character may also be provided by the voice command, to ensure correct detection of the desired AR effect. Accordingly, the voice command may include: “Character 1 says: “I've got you!” The scenes illustrated in views 200 and 220 may be recorded (e.g., by the recording device 132).

View 240 includes a resulting scene to be recorded as stop-motion content, based on the scenes illustrated in views 200 and 220. A resulting scene may include a frame 242 and expanded view 244 of a portion of the frame 242. As a result of detecting the indication of AR effect (user's gesture and voice command) using content augmentation environment 140 of the apparatus 100 and the actions described in reference to FIG. 1, the corresponding AR effect has been identified and added to the scene, e.g., to Character 1 204. Namely, the character to pronounce the narrative has been identified by the gesture and the voice command as noted above. The narrative to be pronounced by Character 1 may be assigned to Character 1. Also, the narrative to be pronounced may be converted into a voice to fit the character, e.g., Character 1's voice. Accordingly, the resulting frame 242 may be a part of the stop-motion content that may include the desired AR effect. The AR effect may be associated with Character 1 204, as directed by the user via a voice command. More specifically, Character 1 204 addresses another character, Character 2 216, with the narrative provided by the user in view 220. As shown in the expanded view 244, Character 1 204 exclaims in her own voice: “I've got you!”

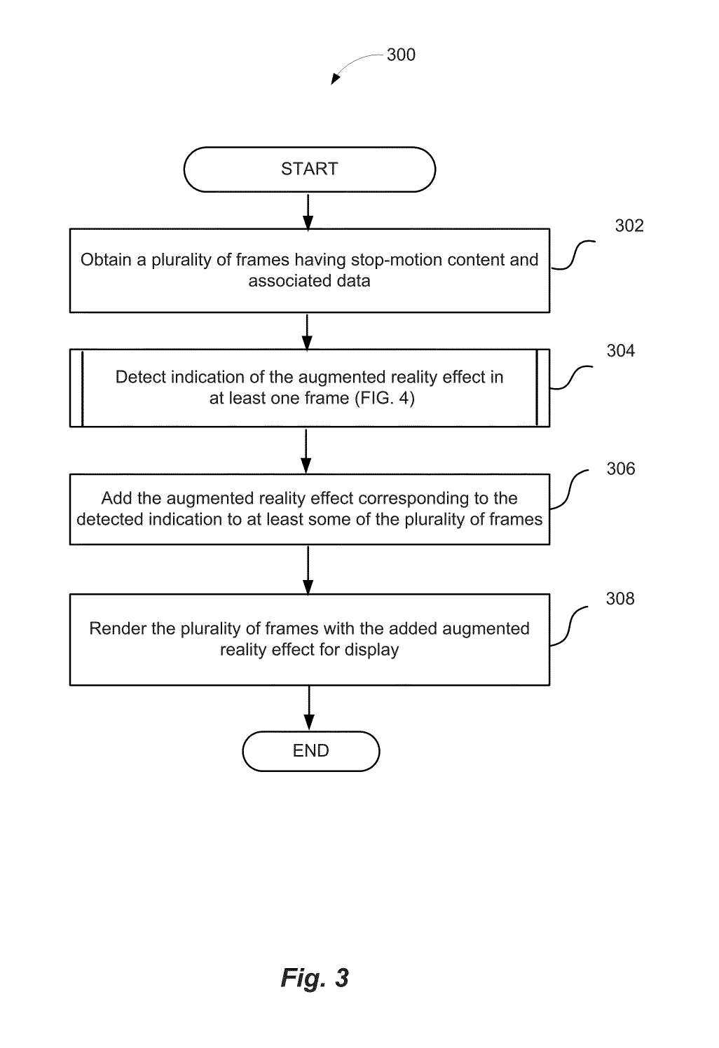

FIG. 3 illustrates an example process for adding an AR effect to stop-motion content, in accordance with some embodiments. The process 300 may be performed, for example, by the apparatus 100 configured with content augmentation environment 140 described in reference to FIG. 1.

The process 300 may begin at block 302, and include obtaining a plurality of frames having stop-motion content. The stop-motion content may include associated data, e.g. user-input indications of AR effect, sensor readings provided by tracking module 110, and the like.

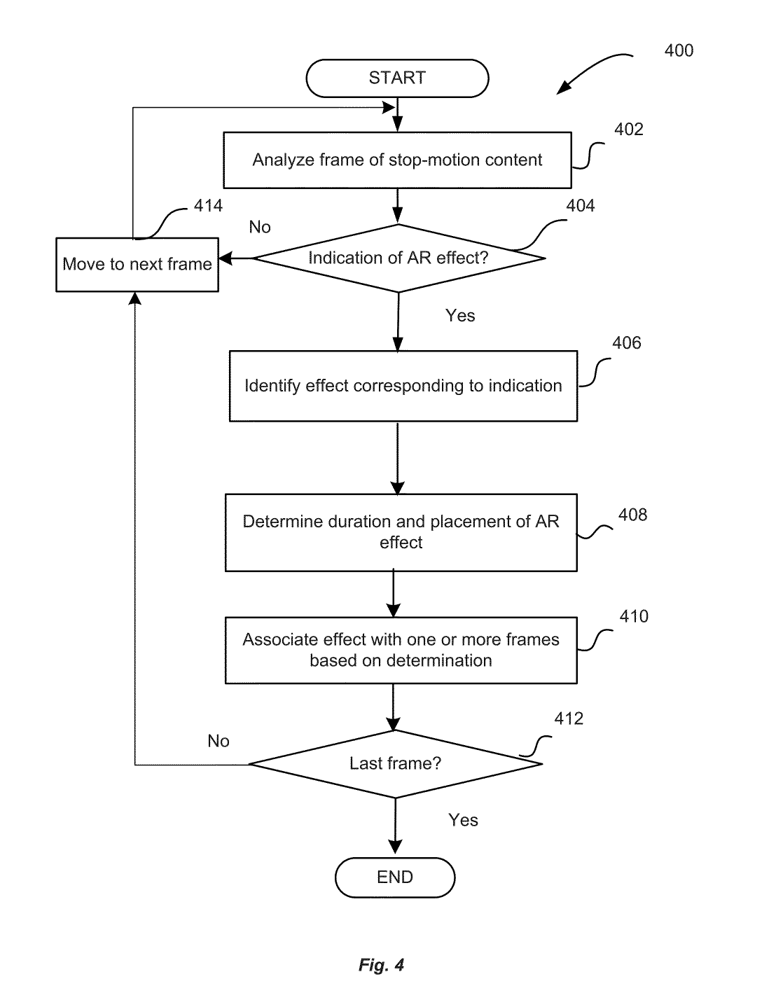

At block 304, the process 300 may include executing, e.g., with augmentation module 120, a routine to detect indication of the augmented reality effect in at least one frame of the stop-motion content. The routine of block 304 is described in greater detail in reference to FIG. 4.

At block 306, the process 300 may include adding the augmented reality effect corresponding to the indication to at least some of the plurality of frames (e.g., by augmentation module 120). In some embodiments, adding the AR effect may occur during second rendering of the recorded stop-motion content, based on association data obtained by routine 304 (see FIG. 4). In other embodiments, adding the AR effect may occur during first rendering of the recorded stop-motion content.

At block 308, the process 300 may include rendering the plurality of frames with the added augmented reality effect for display (e.g., by content rendering module 160).

FIG. 4 illustrates an example routine 400 for detecting an indication of an AR effect in stop-motion content, in accordance with some embodiments. The process 400 may be performed, for example, by the apparatus 100 configured with augmentation module 120 described in reference to FIG. 1.

The process 400 may begin at block 402, and include analyzing a frame of stop-motion content and associated data, in order to detect an indication of an AR effect (if any). As described above, an indication of an AR effect may include a voice command, a fiducial marker, a gesture, a facial expression of a user, or a combination thereof. In some embodiments, an indication of an AR effect may include changes in sensor readings, changes in camera focus, changes in facial expression of a character in the scene, or a combination thereof.

At decision block 404, the process 400 may include determining whether an indication of an AR effect described above has been detected. If no indication has been detected, the process 400 may move to block 416. If an indication of an AR effect has been detected, the process 400 may move to block 406.

At block 406, the process 400 may include identifying an AR effect corresponding to indication. As described in reference to FIG. 1, the AR effect corresponding to detected indication may be identified and retrieved from AR model library 130, for example.

At block 408, the process 400 may include determining duration of the AR effect and placement of the AR effect in the frame. As described above, the duration of the AR effect may be determined from a voice command (which may directly state the duration of the effect), gesture (e.g., indicating a number of frames for which the effect may last), a marker (e.g. of a particular color), and the like. The placement of the AR effect may also be determined from a gesture (that may point at the object with which the AR effect may be associated), a voice command (that may indicate a placement of the AR effect), a marker (that may indicate the placement of the AR effect), and the like.

At block 410, the process 400 may include associating the AR effect with one or more frames based on determination made in block 408. More specifically, the AR effect may be associated with duration and placement data determined at block 408. Alternatively or additionally, the AR effect may be added to the stop-motion content according to the duration and placement data.

At decision block 412, the process 400 may include determining whether the current frame being reviewed is the last frame in the stop-motion content. If the current frame is not the last frame, the process 400 may move to block 414, which may direct the process 400 to move to the next frame to analyze.

It should be understood that the actions described in reference to FIG. 4 may not necessarily occur in the described sequence. For example, actions corresponding to block 408 may take place concurrently with actions corresponding to block 40

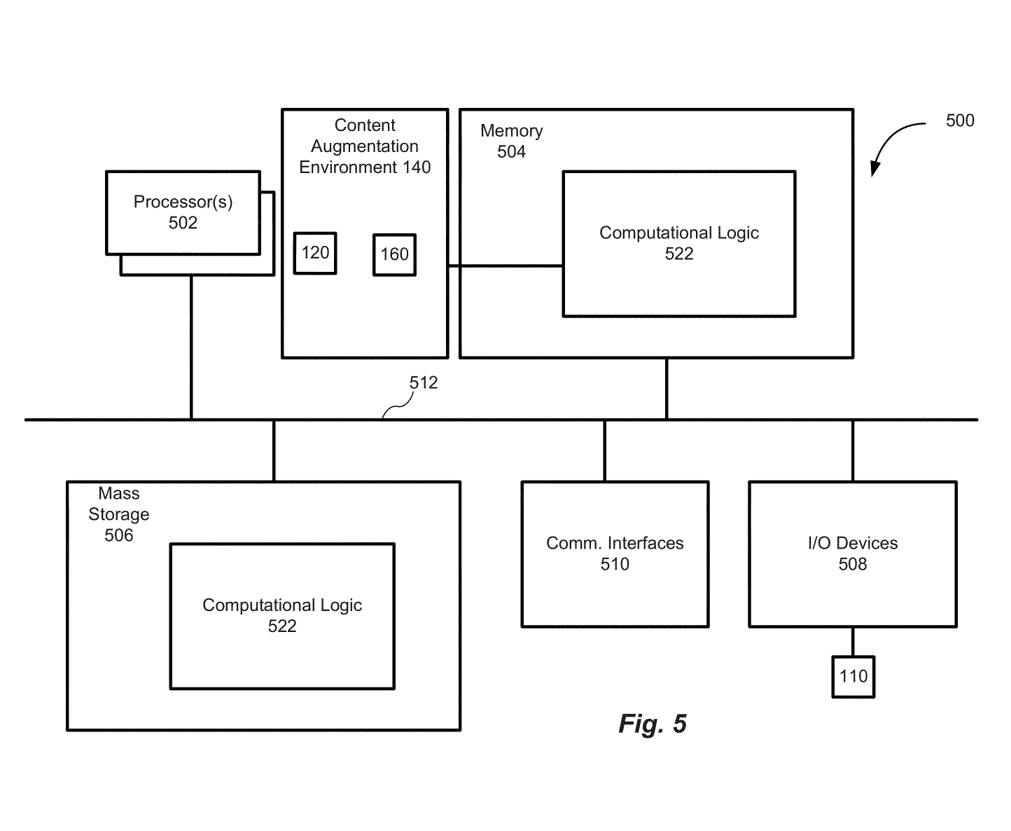

FIG. 5 illustrates an example computing device 500 suitable for use to practice aspects of the present disclosure, in accordance with various embodiments. As shown, computing device 500 may include one or more processors or processor cores 502, and system memory 504. For the purpose of this application, including the claims, the terms “processor” and “processor cores” may be considered synonymous, unless the context clearly requires otherwise. The processor 502 may include any type of processors, such as a central processing unit (CPU), a microprocessor, and the like. The processor 502 may be implemented as an integrated circuit having multi-cores, e.g., a multi-core microprocessor. The computing device 500 may include mass storage devices 506 (such as diskette, hard drive, volatile memory (e.g., DRAM), compact disc read only memory (CD-ROM), digital versatile disk (DVD) and so forth). In general, system memory 504 and/or mass storage devices 506 may be temporal and/or persistent storage of any type, including, but not limited to, volatile and non-volatile memory, optical, magnetic, and/or solid state mass storage, and so forth. Volatile memory may include, but not be limited to, static and/or dynamic random access memory. Non-volatile memory may include, but not be limited to, electrically erasable programmable read only memory, phase change memory, resistive memory, and so forth.

The computing device 500 may further include input/output (I/O) devices 508 (such as a display 134), keyboard, cursor control, remote control, gaming controller, image capture device, and so forth) and communication interfaces (comm. INTF) 510 (such as network interface cards, modems, infrared receivers, radio receivers (e.g., Bluetooth), and so forth). I/O devices 508 may further include components of the tracking module 110, as shown.

The communication interfaces 510 may include communication chips (not shown) that may be configured to operate the device 500 (or 100) in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chips may also be configured to operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chips may be configured to operate in accordance with Code Division Multiple Access (CDMA), Time Division Multiple Access (TDMA), Digital Enhanced Cordless Telecommunications (DECT), Evolution-Data Optimized (EV-DO), derivatives thereof, as well as any other wireless protocols that are designated as 3G, 4G, 5G, and beyond. The communication interfaces 510 may operate in accordance with other wireless protocols in other embodiments.

The above-described computing device 500 elements may be coupled to each other via system bus 512, which may represent one or more buses. In the case of multiple buses, they may be bridged by one or more bus bridges (not shown). Each of these elements may perform its conventional functions known in the art. In particular, system memory 504 and mass storage devices 506 may be employed to store a working copy and a permanent copy of the programming instructions implementing the operations associated with apparatus 100, e.g., operations associated with providing content augmentation environment 140, such as, the augmentation module 120 and rendering module 160 as described in reference to FIGS. 1 and 3-4, generally shown as computational logic 522. Computational logic 522 may be implemented by assembler instructions supported by processor(s) 502 or high-level languages that may be compiled into such instructions.

The permanent copy of the programming instructions may be placed into mass storage devices 506 in the factory, or in the field, through, for example, a distribution medium (not shown), such as a compact disc (CD), or through communication interfaces 510 (from a distribution server (not shown)).

More generally, instructions configured to practice all or selected ones of the operations associated with the processes described may reside on non-transitory computer-readable storage medium or multiple media (e.g., mass storage devices 506). Non-transitory computer-readable storage medium may include a number of programming instructions to enable a device, e.g., computing device 500, in response to execution of the programming instructions, to perform one or more operations of the processes described in reference to FIGS. 3-4. In alternate embodiments, programming instructions may be encoded in transitory computer-readable signals.

The number, capability and/or capacity of the elements 508, 510, 512 may vary, depending on whether computing device 500 is used as a stationary computing device, such as a set-top box or desktop computer, or a mobile computing device, such as a tablet computing device, laptop computer, game console, or smartphone. Their constitutions are otherwise known, and accordingly will not be further described.

At least one of processors 502 may be packaged together with memory having computational logic 522 configured to practice aspects of embodiments described in reference to FIGS. 1-4. For example, computational logic 522 may be configured to include or access content augmentation environment 140, such as component 120 described in reference to FIG. 1. For one embodiment, at least one of the processors 502 may be packaged together with memory having computational logic 522 configured to practice aspects of processes 300 and 400 of FIGS. 3-4 to form a System in Package (SiP) or a System on Chip (SoC).

In various implementations, the computing device 500 may comprise a laptop, a netbook, a notebook, an ultrabook, a smartphone, a tablet, a personal digital assistant (PDA), an ultra mobile PC, a mobile phone, a desktop computer, a server, a printer, a scanner, a monitor, a set-top box, an entertainment control unit, a digital camera, a portable music player, or a digital video recorder. In further implementations, the computing device 500 may be any other electronic device that processes data.

The following paragraphs describe examples of various embodiments. Example 1 is an apparatus for augmenting stop-motion content, comprising: a processor; a content module to be operated by the processor to obtain a plurality of frames having stop-motion content, wherein one or more of the plurality of frames include an indication of an augmented reality effect; and an augmentation module to be operated by the processor to detect the indication of the augmented reality effect; and add the augmented reality effect corresponding to the indication to at least some of the plurality of frames having the stop motion content.

Example 2 may include the subject matter of Example 1, wherein the content module is to further render the plurality of frames with the added augmented reality effect for display, wherein the plurality of frames with the added augmented reality effect forms a stop-motion video.

Example 3 may include the subject matter of Example 1, wherein the augmentation module is to retrieve the augmented reality effect from an augmented reality effect repository according to the indication.

Example 4 may include the subject matter of Example 1, wherein the content module to obtain a plurality of frames includes to record each of the plurality of frames including data comprising user input, wherein the user input comprises the indication of the augmented reality effect associated with the one or more frames.

Example 5 may include the subject matter of Example 4, wherein the indication of the augmented reality effect is selected from one of: a voice command, a fiducial marker, a gesture, a facial expression of a user, or a combination thereof.

Example 6 may include the subject matter of Example 1, wherein the augmentation module to detect the indication of the augmented reality effect includes to analyze each of the plurality of frames for the indication of the augmented reality effect.

Example 7 may include the subject matter of Example 1, wherein an augmentation module to add the augmented reality effect includes to determine a placement and duration of the augmented reality effect in relation to the stop-motion content.

Example 8 may include the subject matter of any of Examples 1 to 7, wherein the augmentation module to detect the indication of the augmented reality effect includes to identify one or more events comprising the indication of the augmented reality effect, independent of user input.

Example 9 may include the subject matter of Example 8, wherein the augmentation module to identify one or more events includes to obtain readings provided by one or more sensors associated with an object captured in the one or more frames.

Example 10 may include the subject matter of Example 9, wherein the augmentation module to identify one or more events includes to detect a combination of a change in camera focus and corresponding change in the sensor readings associated with the one or more frames.

Example 11 may include the subject matter of any of Examples 1 to 10, wherein the content module to obtain a plurality of frames having stop-motion content includes to: obtain a video having a first plurality of frames; detect user manipulations with one or more objects in at least some of the frames; and exclude those frames that included detected user manipulations to form a second plurality of frames, wherein the second plurality of frames includes a plurality of frames that contains the stop-motion content.

Example 12 is a computer-implemented method for augmenting stop-motion content, comprising: obtaining, by a computing device, a plurality of frames comprising stop-motion content, wherein one or more of the plurality of frames include an indication of an augmented reality effect; detecting, by the computing device, the indication of the augmented reality effect; and adding, by the computing device, the augmented reality effect corresponding to the indication to at least some of the plurality of frames comprising the stop motion content.

Example 13 may include the subject matter of Example 12, further comprising: rendering, by the computing device, the plurality of frames with the added augmented reality effect for display.

Example 14 may include the subject matter of Example 12, wherein obtaining a plurality of frames includes recording, by the computing device, each of the plurality of frames including data comprising user input, wherein user input comprises the indication of the augmented reality effect associated with the one or more frames.

Example 15 may include the subject matter of any of Examples 12 to 14, wherein further comprising: analyzing, by the computing device, each of the plurality of frames for the indication of the augmented reality effect.

Example 16 may include the subject matter of any of Examples 12 to 15, wherein detecting the indication of the augmented reality effect includes obtaining, by the computing device, readings provided by one or more sensors associated with an object captured in the one or more frames.

Example 17 is one or more computer-readable media having instructions for augmenting stop-motion content stored thereon which, in response to execution by a computing device, provide the computing device with a content augmentation environment to: obtain a plurality of frames comprising stop-motion content, wherein one or more of the plurality of frames include an indication of an augmented reality effect; and detect the indication of the augmented reality effect; and add the augmented reality effect corresponding to the indication to at least some of the plurality of frames comprising the stop motion content.

Example 18 may include the subject matter of Example 17, wherein the content augmentation environment is to retrieve the augmented reality effect from an augmented reality effect repository according to the indication.

Example 19 may include the subject matter of any of Examples 17 to 18, wherein the content augmentation environment is to record each of the plurality of frames including data comprising user input, wherein user input comprises the indication of the augmented reality effect associated with the one or more frames.

Example 20 may include the subject matter of any of Examples 17 to 19, wherein the content augmentation environment is to analyze each of the plurality of frames for the indication of the augmented reality effect.

Example 21 is an apparatus for augmenting stop-motion content, comprising: means for obtaining a plurality of frames comprising stop-motion content, wherein one or more of the plurality of frames include an indication of an augmented reality effect; means for detecting the indication of the augmented reality effect; and means for adding the augmented reality effect corresponding to the indication to at least some of the plurality of frames comprising the stop motion content.

Example 22 may include the subject matter of Example 21, further comprising: means for rendering the plurality of frames with the added augmented reality effect for display.

Example 23 may include the subject matter of Example 21, wherein means for obtaining a plurality of frames includes means for recording each of the plurality of frames including data comprising user input, wherein user input comprises the indication of the augmented reality effect associated with the one or more frames.

Example 24 may include the subject matter of any of Examples 21-23, wherein further comprising: means for analyzing each of the plurality of frames for the indication of the augmented reality effect.

Example 25 may include the subject matter of any of Examples 21-24, wherein means for detecting the indication of the augmented reality effect includes means for obtaining readings provided by one or more sensors associated with an object captured in the one or more frames.

Computer-readable media (including non-transitory computer-readable media), methods, apparatuses, systems, and devices for performing the above-described techniques are illustrative examples of embodiments disclosed herein. Additionally, other devices in the above-described interactions may be configured to perform various disclosed techniques.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

What is claimed is:

1. An apparatus comprising:
a processor;
a content module to be operated by the processor to obtain a plurality of frames having stop-motion content, wherein one or more of the plurality of frames include an indication of an augmented reality effect; and
an augmentation module to be operated by the processor to:
detect the indication of the augmented reality effect; and
add the augmented reality effect corresponding to the indication to at least some of the plurality of frames having the stop motion content.

2. The apparatus of claim 1, wherein the content module is to further render the plurality of frames with the added augmented reality effect for display, wherein the plurality of frames with the added augmented reality effect forms a stop-motion video.

3. The apparatus of claim 1, wherein the augmentation module is to retrieve the augmented reality effect from an augmented reality effect repository according to the indication.

4. The apparatus of claim 1, wherein the content module to obtain a plurality of frames includes to record each of the plurality of frames including data comprising user input, wherein the user input comprises the indication of the augmented reality effect associated with the one or more frames.

5. The apparatus of claim 4, wherein the indication of the augmented reality effect is selected from one of: a voice command, a fiducial marker, a gesture, a facial expression of a user, or a combination thereof.

6. The apparatus of claim 1, wherein the augmentation module to detect the indication of the augmented reality effect includes to analyze each of the plurality of frames for the indication of the augmented reality effect.

7. The apparatus of claim 1, wherein an augmentation module to add the augmented reality effect includes to determine a placement and duration of the augmented reality effect in relation to the stop-motion content.

8. The apparatus of claim 1, wherein the augmentation module to detect the indication of the augmented reality effect includes to identify one or more events comprising the indication of the augmented reality effect, independent of user input.

9. The apparatus of claim 8, wherein the augmentation module to identify one or more events includes to obtain readings provided by one or more sensors associated with an object captured in the one or more frames.

10. The apparatus of claim 9, wherein the augmentation module to identify one or more events includes to detect a combination of a change in camera focus and corresponding change in the sensor readings associated with the one or more frames.

11. The apparatus of claim 1, wherein the content module to obtain a plurality of frames having stop-motion content includes to:
obtain a video having a first plurality of frames;
detect user manipulations with one or more objects in at least some of the frames; and
exclude those frames that included detected user manipulations to form a second plurality of frames, wherein the second plurality of frames includes a plurality of frames that contains the stop-motion content.

12. A computer-implemented method, comprising:
obtaining, by a computing device, a plurality of frames comprising stop-motion content, wherein one or more of the plurality of frames include an indication of an augmented reality effect;
detecting, by the computing device, the indication of the augmented reality effect; and
adding, by the computing device, the augmented reality effect corresponding to the indication to at least some of the plurality of frames comprising the stop motion content.

13. The computer-implemented method of claim 12, further comprising:
rendering, by the computing device, the plurality of frames with the added augmented reality effect for display.

14. The computer-implemented method of claim 12, wherein obtaining a plurality of frames includes recording, by the computing device, each of the plurality of frames including data comprising user input, wherein user input comprises the indication of the augmented reality effect associated with the one or more frames.

15. The computer-implemented method of claim 12, further comprising:
analyzing, by the computing device, each of the plurality of frames for the indication of the augmented reality effect.

16. The computer-implemented method of claim 12, wherein detecting the indication of the augmented reality effect includes obtaining, by the computing device, readings provided by one or more sensors associated with an object captured in the one or more frames.

17. One or more computer-readable media having instructions stored thereon which, in response to execution by a computing device, provide the computing device with a content augmentation environment to:
obtain a plurality of frames comprising stop-motion content, wherein one or more of the plurality of frames include an indication of an augmented reality effect; and
detect the indication of the augmented reality effect; and add the augmented reality effect corresponding to the indication to at least some of the plurality of frames comprising the stop motion content.

18. The computer-readable media of claim 17, wherein the content augmentation environment is to retrieve the augmented reality effect from an augmented reality effect repository according to the indication.

19. The computer-readable media of claim 17, wherein the content augmentation environment is to record each of the plurality of frames including data comprising user input, wherein user input comprises the indication of the augmented reality effect associated with the one or more frames.

20. The computer-readable media of claim 17, wherein the content augmentation environment is to analyze each of the plurality of frames for the indication of the augmented reality effect.
